(19) United States
(12) Patent Application Publication
(10) Pub. No.: US 2022/0271303 A1
(43) Pub. Date: Aug. 25, 2022

(54) SEPARATOR FOR FUEL CELL AND METHOD OF MANUFACTURING POWER GENERATING CELL STACKED BODY

(71) Applicant: HONDA MOTOR CO., LTD., Tokyo (JP)

(72) Inventors: Kazuyoshi MIYAJIMA, Wako-shi (JP); Yoshihito KIMURA, Wako-shi (JP)

(21) Appl. No.: 17/665,559

(22) Filed: Feb. 6, 2022

(30) Foreign Application Priority Data
Feb. 22, 2021 (JP) 2021-026002

(51) Int. Cl. H01M 8/0247; H01M 8/2404; H01M 8/247

(52) U.S. Cl. CPC H01M 8/0247; H01M 8/2404; H01M 8/247

(57) ABSTRACT

A separator for a fuel cell forms a stacked unit of a power generating cell stacked body. The separator is made up from a connected body of a first bipolar plate and a second bipolar plate that are stacked on each other, and is provided with positioning parts. The positioning parts are disposed at positions overlapping in the stacking direction with respect to each of the first bipolar plate and the second bipolar plate. A first positioning edge portion of the first bipolar plate and a second positioning edge portion of the second bipolar plate are at different positions from each other in a separator surface direction.

### CROSS-REFERENCE TO RELATED APPLICATIONS

This application is based upon and claims the benefit of priority from Japanese Patent Application No. 2021-026002 filed on Feb. 22, 2021, the contents of which are incorporated herein by reference.

### BACKGROUND OF THE INVENTION

### Field of the Invention

The present invention relates to a separator for a fuel cell, and a method of manufacturing a power generating cell stacked body.

### Description of the Related Art

Fuel cells are commonly used in the form of a fuel cell stack. Such a fuel cell stack is equipped with a power generating cell stacked body in which a plurality of power generating cells (unit fuel cells) are stacked, and end plates arranged on both ends in the stacking direction of the power generating cell stacked body. The power generating cells are constituted by sandwiching membrane electrode assemblies between pairs of separators. This type of fuel cell stack may constitute a so-called internal manifold. In such an internal manifold, fluids such as reaction gases are supplied to each of the membrane electrode assemblies of the power generating cell stacked body. In this case, in order to satisfactorily ensure fluid sealing performance, it is necessary to stack the stacked units of the power generating cell stacked body in a state of being positioned with high accuracy.

Thus, for example, as disclosed in JP 2013-196849 A, it may be considered to provide positioning holes in the stacked units. The positioning holes of the plurality of stacked units are superimposed on each other in the stacking direction. Consequently, the stacked units are arranged so as to be positioned in predetermined stacking positions. By providing the positioning holes in this manner, for example, by using an assembly device in which knock pins are provided on a pedestal plate, it becomes possible to easily position the stacked units. More specifically, the knock pins are inserted through the positioning holes, and a plurality of stacked units are stacked on the pedestal plate while inner circumferential surfaces of the positioning holes are aligned with outer circumferential surfaces of the knock pins. Consequently, since the positioning holes are overlapped with each other in the stacking direction, the plurality of stacked units can be stacked in a mutually positioned state.

### SUMMARY OF THE INVENTION

Incidentally, the separators may be constituted from bonded bodies in which first bipolar plates and second bipolar plates are laminated and joined in a stacking direction. In this case, the positioning holes provided in the separators are through holes that integrally penetrate through the first bipolar plates and the second bipolar plates in the stacking direction. Therefore, both the edge portions of the positioning holes of the first bipolar plates and the edge portions of the positioning holes of the second bipolar plates are stacked to thereby form the inner circumferential surfaces of the positioning holes.

As described above, in the case that the stacked units in which the positioning holes are provided are stacked, for example, using knock pins, frictional forces are generated between the inner circumferential surfaces of the positioning holes and the outer circumferential surfaces of the knock pins. In this case, if the inner circumferential surfaces of the positioning holes are formed from both the first bipolar plate and the second bipolar plate, the aforementioned frictional forces tend to become larger. In the case that the above-described frictional forces are large, a concern arises in that the stacked units may be deformed. In the power generating cell stacked body, it is necessary to maintain the adjacent separators in an electrically insulated state.

In view of the above-described situation, it is desirable for the stacked units to be capable of being easily positioned, together with enabling deformation of the separators to be suppressed.

The present invention has the object of solving the aforementioned problem.

One aspect of the present invention is characterized by a separator for a fuel cell configured to be stacked on a membrane electrode assembly in which electrodes are arranged on both sides of an electrolyte membrane to thereby form a stacked unit, wherein a plurality of the stacked units are stacked in a stacking direction to thereby form a power generating cell stacked body, the separator is a connected body of a first bipolar plate and a second bipolar plate that are stacked on each other, the separator is provided with a positioning structure, the positioning structure comprises a positioning part provided for the first bipolar plate and a positioning part provided for the second bipolar plate, the stacked units are positioned by superimposing the positioning structures of a plurality of the separators in the stacking direction, the positioning part of the first bipolar plate and the positioning part of the second bipolar plate are disposed at positions overlapping each other in the stacking direction, the first bipolar plate comprises a first positioning edge portion that is an edge portion of the positioning part of the first bipolar plate, the second bipolar plate comprises a second positioning edge portion that is an edge portion of the positioning part of the second bipolar plate, and a position of the first positioning edge portion in a separator surface direction that is perpendicular with respect to a thickness direction of the separator, and a position of the second positioning edge portion in the separator surface direction differ from each other.

Another aspect of the present invention is characterized by a method of manufacturing a power generating cell stacked body in which a plurality of stacked units, in which there are superimposed a membrane electrode assembly having electrodes arranged on both surfaces of an electrolyte membrane and a separator, are stacked in a stacking direction to thereby obtain the power generating cell stacked body, wherein the separators comprise positioning structures in which the stacked units are positioned with respect to each other by being superimposed in the stacking direction, the method of manufacturing the power generating cell stacked body comprising a stacked unit forming step of forming the stacked units from the separators and the membrane electrode assemblies, and a stacking step of stacking the plurality of stacked units on a mounting pedestal, by aligning the positioning structures of the stacked units with a guide bar configured to project out from the mounting pedestal in the stacking direction, while superimposing the positioning structures of the plurality of stacked units in the stacking direction, wherein each of the separators is made up from a connected body of a first bipolar plate and a second bipolar plate that are stacked on each other, the positioning structure comprises a positioning part provided for the first bipolar plate and a positioning part provided for the second bipolar plate, the positioning part of the first bipolar plate and the positioning part of the second bipolar plate are disposed at positions overlapping each other in the stacking direction, and a first positioning edge portion that is an edge portion of the positioning part of the first bipolar plate, and a second positioning edge portion that is an edge portion of the positioning part of the second bipolar plate are at different positions in a separator surface direction that is perpendicular with respect to a thickness direction of the separator.

The separators are provided with the positioning parts with which the stacked units are positioned due to being superimposed on each other in the stacking direction. For example, by stacking a plurality of the stacked units while aligning the positioning parts along the guide bar, the positioning parts themselves can be superimposed in the stacking direction. As a result, the plurality of stacked units can be easily stacked in a mutually positioned state.

Further, each of the separators is made up from the connected body of the first bipolar plate and the second bipolar plate. The positioning parts of the separators each include a first positioning edge portion that is an edge portion of the positioning part of the first bipolar plate, and a second positioning edge portion that is an edge portion of the positioning part of the second bipolar plate. Positions of the first positioning edge portion and the second positioning edge portion in the separator surface direction are different from each other. Therefore, at a time when the plurality of stacked units are stacked in a state of being mutually positioned together in the manner described above, it is possible to avoid a situation in which both the first positioning edge portion and the second positioning edge portion are oriented along the guide bar. More specifically, it becomes possible to reduce the contact area between the positioning parts and the guide bar. As a result, any frictional forces generated between the positioning parts and the guide bar can be reduced, and deformation of the separators can be suppressed.

Therefore, according to the present invention, the stacked units themselves are capable of being easily positioned, together with enabling deformation of the separators to be suppressed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a fuel cell stack according to a present embodiment;

FIG. 2 is an exploded perspective view of a power generating cell equipped with a separator for a fuel cell according to the present embodiment;

FIG. 3 is an explanatory view of a membrane electrode assembly (MEA) side surface of a first bipolar plate in the separator;

FIG. 4A is an enlarged view of a first positioning part shown in FIG. 3;

FIG. 4B is an enlarged view of a second positioning part shown in FIG. 3;

FIG. 4C is an enlarged view of a third part shown in FIG. 3;

FIG. 5 is an explanatory perspective view of the third positioning part shown in FIG. 4C;

FIG. 6 is a schematic plan view of a manufacturing apparatus for manufacturing a power generating cell stacked body of the fuel cell stack;

FIG. 7 is a schematic cross-sectional view taken along line VII-VII of FIG. 6;

FIG. 8 is an explanatory view in which a pressurizing unit is brought into close proximity to a mounting pedestal shown in FIG. 7;

FIG. 9 is an explanatory view in which the pressurizing unit is brought further into close proximity to the mounting pedestal shown in FIG. 8;

FIG. 10A is a cross-sectional view taken along line XA-XA of FIG. 6 for the purpose of explaining an embodiment in which stacked units, in which second positioning edge portions thereof project out more than first positioning edge portions thereof, are stacked;

FIG. 10B is an explanatory view for the purpose of explaining an embodiment in which stacked units, in which first positioning edge portions thereof project out more than second positioning edge portions thereof, are stacked.

### DESCRIPTION OF THE INVENTION

In the following figures, there are cases in which components having the same or similar functions and effects may be designated by the same reference numerals, and repeated description of such features is omitted.

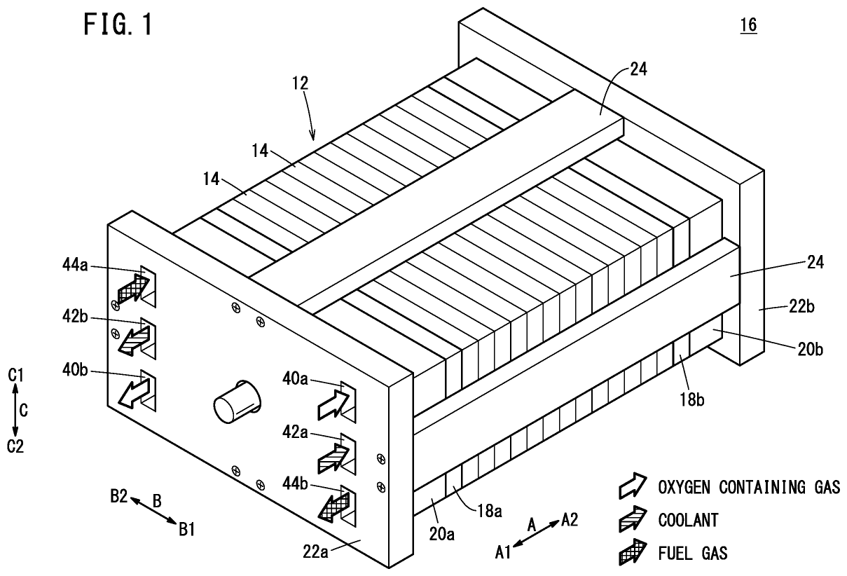

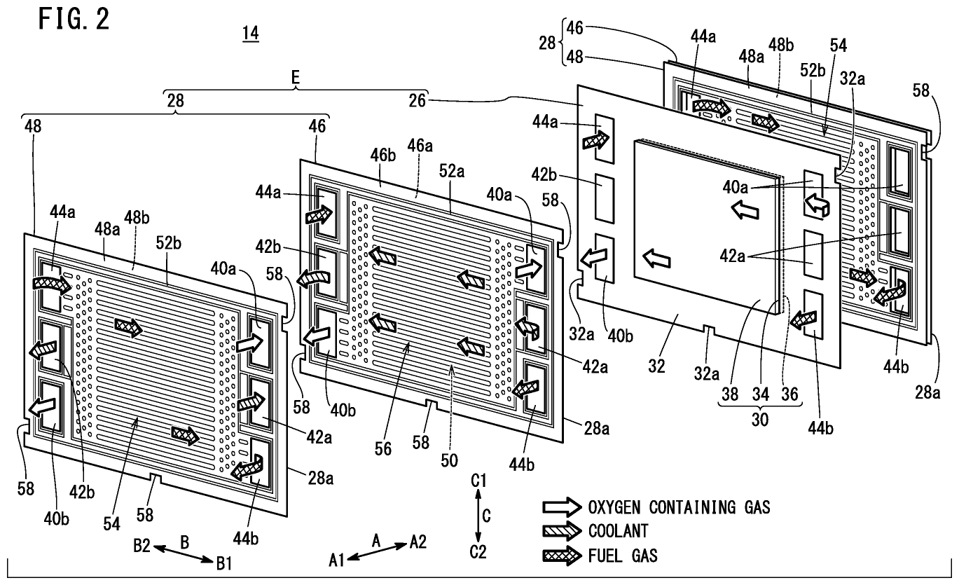

A fuel cell stack 16, which is provided with separators 28 (see FIG. 2) for the fuel cell according to the present embodiment shown in FIG. 1, can be mounted and used in a fuel cell vehicle such as a non-illustrated fuel cell electric automobile. Further, the fuel cell stack 16 can also be used as a stationary type of fuel cell stack. A power generating cell stacked body 12, which is obtained by applying the method of manufacturing a power generating cell stacked body according to the present embodiment, is provided in the fuel cell stack 16. In the power generating cell stacked body 12, a plurality of power generating cells 14 are stacked in a stacking direction (the direction of the arrow A).

A terminal plate 18a, an insulator 20a, and an end plate 22a are arranged in this order sequentially toward an outer side on one end part (an end part in the direction of the arrow A1) in the stacking direction of the power generating cell stacked body 12. Further, a terminal plate 18b, an insulator 20b, and an end plate 22b are arranged in this order sequentially toward an outer side on another end part (an end part in the direction of the arrow A2) in the stacking direction of the power generating cell stacked body 12.

The insulators 20a and 20b are formed by an insulating material, for example, such as polycarbonate (PC), phenol resin, or the like. Further, each of the insulators 20a and 20b may be constituted from a plurality of sheets (for example, two sheets) that are superimposed in the stacking direction. Further, although not shown in the drawings, recesses, which are recessed toward sides separated away from the power generating cell stacked body 12, may be formed on surfaces of each of the insulators 20a and 20b facing toward the power generating cell stacked body 12. In this case, the terminal plate 18a is disposed inside the recess of the insulator 20a. The terminal plate 18b is disposed inside the recess of the insulator 20b.

Connecting bars 24 are arranged between respective sides of the end plate 22a and respective sides of the end plate 22b. One end of each of the connecting bars 24 is fixed to an inner surface of the end plate 22a via bolts or the like. Another end of each of the connecting bars 24 is fixed to an inner surface of the end plate 22b via bolts or the like. By fixing the connecting bars 24 to the end plates 22a and 22b, a compressive load (tightening load) in the stacking direction is applied to the power generating cell stacked body 12. Moreover, the fuel cell stack 16 may include a housing having the end plates 22a and 22b as end plates thereof. In this case, the power generating cell stacked body 12 is accommodated in the housing.

As shown in FIG. 2, each of the power generating cells 14 includes a resin frame equipped MEA 26, and a pair of separators 28 that sandwich the resin frame equipped MEA 26 therebetween. The resin frame equipped MEA 26 includes a membrane electrode assembly (MEA) 30, and a frame-shaped resin frame member 32 that surrounds an outer periphery of the membrane electrode assembly 30. The membrane electrode assembly 30 includes an electrolyte membrane 34, an anode 36, and a cathode 38. The anode 36 is disposed on one surface of the electrolyte membrane 34. The cathode 38 is disposed on another surface of the electrolyte membrane 34.

The electrolyte membrane 34, for example, is a solid polymer electrolyte membrane (cation ion exchange membrane) such as a thin membrane of perfluorosulfonic acid with water impregnated therein. The electrolyte membrane 34 is sandwiched between the anode 36 and the cathode 38. In addition to the fluorine based electrolyte, an HC (hydrocarbon) based electrolyte may be used as the electrolyte membrane 34.

Each of the anodes 36 has a non-illustrated anode electrode catalyst layer and an anode gas diffusion layer. The anode electrode catalyst layer is coupled to one surface of the electrolyte membrane 34. The anode gas diffusion layer is laminated on the anode electrode catalyst layer. Each of the cathodes 38 has a non-illustrated cathode electrode catalyst layer and a cathode gas diffusion layer. The cathode electrode catalyst layer is coupled to the other surface of the electrolyte membrane 34. The cathode gas diffusion layer is laminated on the cathode electrode catalyst layer.

The anode electrode catalyst layer is formed, for example, by uniformly coating the surface of the anode gas diffusion layer with porous carbon particles on which a platinum alloy is supported, and an ion conductive polymer binder. The cathode electrode catalyst layer is formed, for example, by uniformly coating the surface of the cathode gas diffusion layer with porous carbon particles on which a platinum alloy is supported, and an ion conductive polymer binder.

Each of the cathode gas diffusion layer and the anode gas diffusion layer is formed from a conductive porous sheet such as carbon paper or carbon cloth. A porous layer (not shown) may be provided between at least one of the cathode electrode catalyst layer and the cathode gas diffusion layer, and between the anode electrode catalyst layer and the anode gas diffusion layer.

For example, an inner peripheral edge portion of the resin frame member 32 is joined to an outer peripheral edge portion of the membrane electrode assembly 30. By providing the resin frame member 32 on the membrane electrode assembly 30 in this manner, for example, the area of the electrolyte membrane 34 required to form one of the power generating cells 14 can be reduced. The electrolyte membrane 34 is relatively expensive. Therefore, by reducing the area required to form one of the power generating cells 14, it becomes possible to reduce the material cost of the membrane electrode assembly 30.

The bonding structure between the resin frame member 32 and the membrane electrode assembly 30 is not limited to the structure described above. As an example of the bonding structure between the resin frame member 32 and the membrane electrode assembly 30, there may be cited a method of sandwiching the inner peripheral edges of the resin frame member 32 between the outer peripheral edge of the cathode gas diffusion layer and the outer peripheral edge of the anode gas diffusion layer. In this case, an inner peripheral end surface of the resin frame member 32 may be placed in close proximity to, may be placed in contact with, or may be overlapped with an outer peripheral end surface of the electrolyte membrane 34.

As another example of the bonding structure between the resin frame member 32 and the membrane electrode assembly 30, there may be cited a method of allowing the outer peripheral edge portion of the electrolyte membrane 34 to project out from each of the cathode gas diffusion layer and the anode gas diffusion layer. Frame-shaped films are provided on both sides of the outer peripheral edge portion of the electrolyte membrane 34. A plurality of the frame-shaped films are laminated with the electrolyte membrane 34 being interposed therebetween. The laminated frame-shaped films are joined to each other with an adhesive or the like to thereby form the resin frame member 32.

As shown in FIGS. 1 and 2, oxygen containing gas supply passages 40a, coolant supply passages 42a, and fuel gas discharge passages 44b are provided so as to be arranged along the direction of the arrow C, on one end part (an end part in the direction of the arrow B1) in a longitudinal direction of each of the power generating cells 14, the end plate 22a, and the insulators 20a and 20b. Fuel gas supply passages 44a, coolant discharge passages 42b, and oxygen containing gas discharge passages 40b are provided so as to be arranged along the direction of the arrow C, on another end part (an end part in the direction of the arrow B2) in a longitudinal direction of each of the power generating cells 14, the end plate 22a, and the insulators 20a and 20b.

An oxidizing gas (for example, an oxygen containing gas) is supplied to oxygen containing gas supply passages 40a. A coolant (for example, at least one of pure water, ethylene glycol, and oil) is supplied to the coolant supply passages 42a. A fuel gas (for example, a hydrogen containing gas) is discharged from the fuel gas discharge passages 44b. The fuel gas is supplied to the fuel gas supply passages 44a. The coolant is discharged through the coolant discharge passages 42b. The oxygen containing gas is discharged from the oxygen containing gas discharge passages 40b.

The oxygen containing gas supply passages 40a, which are provided in the power generating cells 14, the end plate 22a, and the insulators 20a and 20b in the power generating cell stacked body 12, communicate with each other in the stacking direction. Stated otherwise, the oxygen containing gas supply passages 40a penetrate in the stacking direction through the end plate 22a, the insulators 20a and 20b, and the power generating cell stacked body 12. Similarly, each of the coolant supply passages 42a, the fuel gas discharge passages 44b, the fuel gas supply passages 44a, the coolant discharge passages 42b, and the oxygen containing gas discharge passages 40b also penetrates in the stacking direction through the end plate 22a, the insulators 20a and 20b, and the power generating cell stacked body 12.

In the present embodiment, in each of the power generating cells 14, there are provided one each of the oxygen containing gas supply passages 40a, the coolant supply passages 42a, the fuel gas discharge passages 44b, the fuel gas supply passages 44a, the coolant discharge passages 42b, and the oxygen containing gas discharge passages 40b (hereinafter, collectively referred to simply as “communication passages”). However, the number of each of the communication holes provided in each of the power generating cells 14 is not limited to any particular number, and may be a single number or a plural number. Further, the shape and the arrangement of the respective communication holes are not limited to those of the present embodiment shown in FIGS. 1 and 2, and can be appropriately set in accordance with required specifications.

As shown in FIG. 2, each of the separators 28 is formed in a rectangular shape having a pair of longitudinal sides and a pair of lateral sides. The longitudinal sides of the pair of separators 28 are arranged at an interval in the direction of the arrow C. According to the present embodiment, the longitudinal sides of the pair of separators 28 are arranged in parallel or substantially in parallel with each other. The lateral sides of the pair of separators 28 are arranged at an interval in the direction of the arrow B. According to the present embodiment, the lateral sides of the pair of separators 28 are arranged in parallel or substantially in parallel with each other. Each of the separators 28 is constituted by stacking on each other a first bipolar plate 46 and a second bipolar plate 48. An outer periphery of the first bipolar plate 46 and an outer periphery of the second bipolar plate 48, in a state of being stacked on one another, are integrally joined together, for example, by welding, brazing, caulking, or the like. Each of the first bipolar plate 46 and the second bipolar plate 48 is formed, for example, by press-molding a cross section of a thin metal plate into a corrugated shape. As an example of such a thin metal plate, there may be cited a steel plate, a stainless steel plate, an aluminum plate, a plated steel plate, a titanium plate, or a plate on which the metal surfaces thereof have been subjected to an anti-corrosive surface treatment. An insulating resin material may be provided on outer edges of the separators 28.

The first bipolar plate 46 includes an MEA side surface 46a, which is a surface facing toward the resin frame equipped MEA 26, and a coolant side surface 46b, which is a rear surface thereof. The second bipolar plate 48 includes an MEA side surface 48a, which is a surface facing toward the resin frame equipped MEA 26, and a coolant side surface 48b, which is a rear surface thereof.

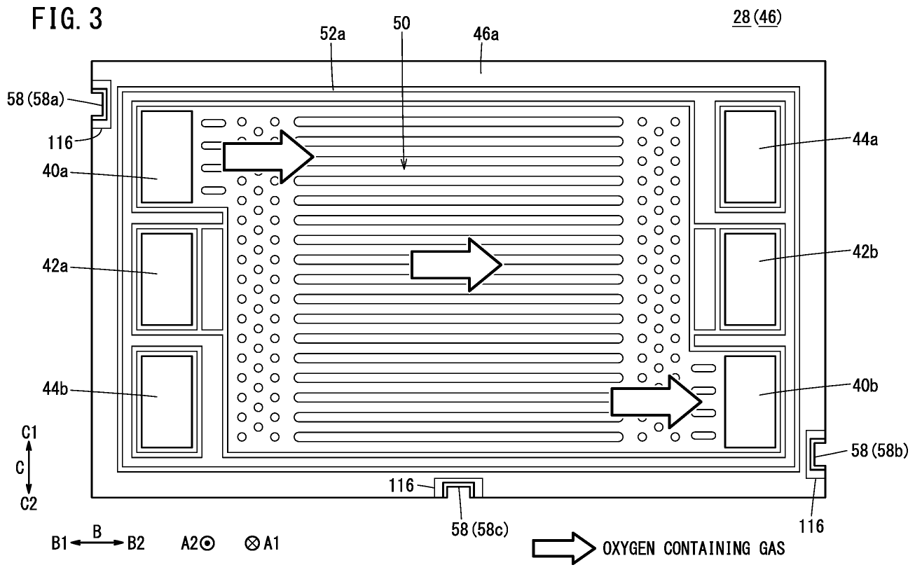

As shown in FIG. 3, in the MEA side surface 46a of the first bipolar plate 46, there are provided a plurality of ridge portions that extend linearly in the direction of the arrow B. The ridge portions, inside of grooves therebetween, form a linear shaped oxygen containing gas flow field 50. Moreover, each of the ridge portions and the oxygen containing gas flow field 50 may be formed in a wave-like shape. The oxygen containing gas flow field 50, by communicating fluidically with the oxygen containing gas supply passages 40a and the oxygen containing gas discharge passages 40b, communicates in a surface direction (the direction of the arrows B and C) of the separators 28.

Further, a metal bead seal 52a projecting toward the resin frame equipped MEA 26 (see FIG. 2) is provided on the MEA side surface 46a of the first bipolar plate 46. The metal bead seal 52a is integrally provided on the first bipolar plate 46, for example, by press-molding the first bipolar plate 46. Instead of the metal bead seal 52a, a convex elastic seal made of an elastic material such as rubber or the like may be provided on the MEA side surface 46a.

One portion of the metal bead seal 52a of the first bipolar plate 46 integrally surrounds the oxygen containing gas flow field 50, the oxygen containing gas supply passages 40a, and the oxygen containing gas discharge passages 40b. On an inner side thereof surrounded by the metal bead seal 52a, the oxygen containing gas flow field 50, the oxygen containing gas supply passages 40a, and the oxygen containing gas discharge passages 40b communicate with each other. Further, another portion of the metal bead seal 52a individually surrounds the fuel gas supply passages 44a, the fuel gas discharge passages 44b, the coolant supply passages 42a, and the coolant discharge passages 42b. In accordance with these features, the metal bead seal 52a prevents the fuel gas and the coolant from flowing into the oxygen containing gas flow field 50.

As shown in FIG. 2, in the MEA side surface 48a of the second bipolar plate 48, there are provided a plurality of ridge portions that extend linearly in the direction of the arrow B. The ridge portions, inside of grooves therebetween, form a linear shaped fuel gas flow field 54. Moreover, each of the ridge portions and the fuel gas flow field 54 may be formed in a wave-like shape. The fuel gas flow field 54, by communicating fluidically with the fuel gas supply passages 44a and the fuel gas discharge passages 44b, allows the fuel gas to flow in a surface direction (the direction of the arrows B and C) of the separators 28.

Further, a metal bead seal 52b projecting toward the resin frame equipped MEA 26 is provided on the MEA side surface 48a of the second bipolar plate 48. The metal bead seal 52b is integrally provided on the second bipolar plate 48, for example, by press-molding the second bipolar plate 48. Instead of the metal bead seal 52b, a convex elastic seal made of an elastic material such as rubber or the like may be provided on the MEA side surface 48a.

One portion of the metal bead seal 52b of the second bipolar plate 48 integrally surrounds the fuel gas flow field 54, the fuel gas supply passages 44a, and the fuel gas discharge passages 44b. On an inner side thereof surrounded by the metal bead seal 52b, the fuel gas flow field 54, the fuel gas supply passages 44a, and the fuel gas discharge passages 44b communicate with each other. Further, another portion of the metal bead seal 52b individually surrounds the oxygen containing gas supply passages 40a, the oxygen containing gas discharge passages 40b, the coolant supply passages 42a, and the coolant discharge passages 42b. In accordance with these features, the metal bead seal 52b prevents the oxygen containing gas and the coolant from flowing into the fuel gas flow field 54.

A coolant flow field 56 is provided between the coolant side surface 46b of the first bipolar plate 46 and the coolant side surface 48b of the second bipolar plate 48. The coolant flow field 56 communicates fluidically with the coolant supply passages 42a and the coolant discharge passages 42b. Consequently, the coolant flow field 56 allows the coolant to flow therethrough in a surface direction (the direction of the arrows B and C) of the separators 28.

The coolant flow field 56 is formed by overlapping and matching together the rear surface shape of the oxygen containing gas flow field 50 of the first bipolar plate 46, and the rear surface shape of the fuel gas flow field 54 of the second bipolar plate 48. Further, a periphery of the coolant side surface 46b and a periphery of the coolant side surface 48b are joined to each other, for example, by welding or brazing, in a state of facing toward each other.

The power generating cell stacked body 12 is formed, for example, by stacking a plurality of stacked units E (see FIG. 2). For example, each of the stacked units E is constituted by overlapping and bonding one of the separators 28 (the first bipolar plate 46 and the second bipolar plate 48), and one of the resin frame equipped MEAs 26 (the membrane electrode assembly 30). In the respective stacked units E, the outer edge portions of the resin frame members 32 may be joined beforehand to the outer edge portions 28a of the separators 28, for example, by welding, adhesion, or the like. Moreover, the respective stacked units E are not limited to being ones in which one of the separators 28 and one of the resin frame equipped MEAs 26 are overlapped and joined. The respective stacked units E may be any type of unit insofar as, ultimately, they are capable of forming the power generating cell stacked body 12 by stacking a plurality of each of the stacked units E.

Positioning parts 58 are provided in the separators 28 of each of the stacked units E. When the respective stacked units E are stacked, the positioning parts 58 of each of the stacked units E are superimposed in the stacking direction, whereby the stacked units E are accurately positioned in relation to each other. According to the present embodiment, the positioning parts 58 are grooves (recesses) that are recessed in the outer edge portions 28a of the separators 28 from an outer side toward an inner side of the separators 28.

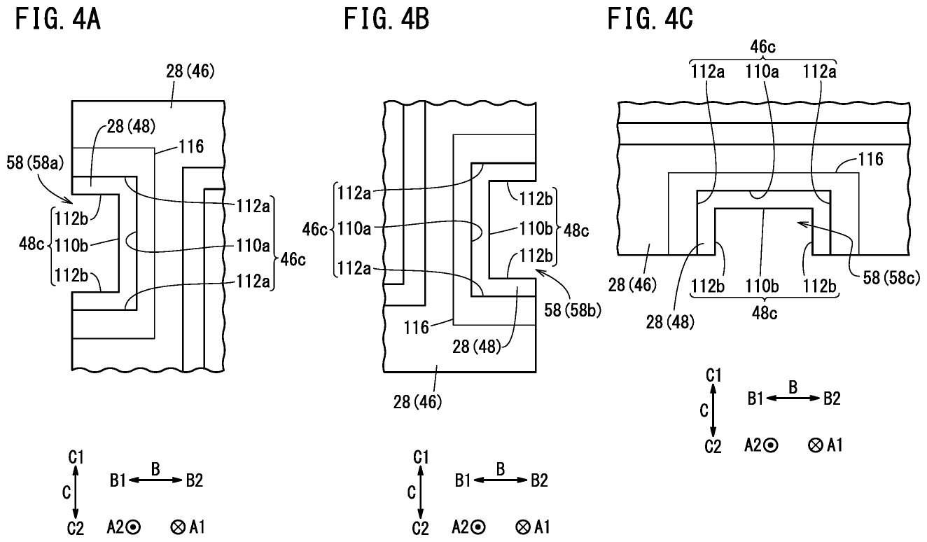

Further, as shown in FIGS. 3 and 4A to 4C, according to the present embodiment, each of the positioning parts 58 includes a first positioning part 58a, a second positioning part 58b, and a third positioning part 58c. More specifically, one of the separators 28 is provided with a total of three of the positioning parts 58.

As shown in FIG. 3, the first positioning part 58a is disposed in close proximity to an end part in the direction of the arrow C1 of the lateral side that is arranged at an end part in the direction of the arrow B1 of the separators 28. The second positioning part 58b is disposed in close proximity to an end part in the direction of the arrow C2 of the lateral side that is arranged at an end part in the direction of the arrow B2 of the separators 28. More specifically, the first positioning part 58a and the second positioning part 58b are arranged at diagonal positions of the separators 28. Moreover, in the direction of the arrow C, the second positioning part 58b may be arranged in closer proximity to an end of the separators 28 in the direction of the arrow C2 than the first positioning part 58a. The third positioning part 58c is disposed in the center or substantially in the center of the longitudinal side that is arranged at the end of the separator 28 in the direction of the arrow C2. Hereinafter, in the case that the first positioning part 58a, the second positioning part 58b, and the third positioning part 58c are not to be distinguished from each other, these elements will be collectively referred to simply as the positioning parts 58.

As shown in FIGS. 3 to 5, the positioning parts 58 are provided on each of the first bipolar plate 46 and the second bipolar plate 48. A positioning structure is constituted by the positioning parts 58 of the first bipolar plate 46 and the positioning parts 58 of the second bipolar plate 48. The positioning parts 58 of the first bipolar plate 46 and the positioning parts 58 of the second bipolar plate 48 overlap each other in the stacking direction. Edge portions of the positioning parts 58 of the first bipolar plate 46 are also referred to as first positioning edge portions 46c. Edge portions of the positioning parts 58 of the second bipolar plate 48 are also referred to as second positioning edge portions 48c. A direction perpendicular to the thickness direction of the separators 28 (in the directions of the arrow B and the arrow C) is referred to as a separator surface direction. Positions in the separator surface direction of the first positioning edge portions 46c, and positions in the separator surface direction of the second positioning edge portions 48c differ from each other. According to the present embodiment, the entirety of the second positioning edge portions 48c projects more toward the outer side (on an inner side of the grooves of the positioning parts 58) in the separator surface direction than the first positioning edge portions 46c.

In this instance, as shown in FIGS. 4A to 4C, each of the first positioning edge portions 46c of the first bipolar plate 46 includes a first side 110a and a pair of second sides 112a. The first side 110a of the first positioning edge portions 46c, on an more inner side of the separators 28 than the outer edge portions 28a of the separators 28, is oriented along a direction of extension of the outer edge portions 28a. The pair of second sides 112a of the first positioning edge portions 46c face toward each other across an interval in the direction of extension of the outer edge portions 28a.

Similarly, each of the second positioning edge portions 48c of the second bipolar plate 48 includes a first side 110b and a pair of second sides 112b. The first side 110b of the second positioning edge portions 48c, on an more inner side of the separators 28 than the outer edge portions 28a of the separators 28, is oriented along a direction of extension of the outer edge portions 28a. The pair of second sides 112b of the second positioning edge portions 48c face toward each other across an interval in the direction of extension of the outer edge portions 28a.

More specifically, as shown in FIG. 4A, the first side 110a of the first positioning edge portions 46c in the first positioning part 58a is in closer proximity to an end part in the direction of the arrow B2 than a lateral side arranged on an end part in the direction of the arrow B1 of the separators 28, and is oriented along the direction of extension (the direction of the arrow C) of the lateral side. Similarly, the first side 110b of the second positioning edge portions 48c in the first positioning part 58a is in closer proximity to an end part in the direction of the arrow B2 than a lateral side arranged on an end part in the direction of the arrow B1 of the separators 28, and is oriented along the direction of extension (the direction of the arrow C) of the lateral side.

The pair of second sides 112a of the first positioning edge portions 46c in the first positioning part 58a face toward each other across an interval in the direction (groove width direction) of the arrow C. Similarly, the pair of second sides 112b of the second positioning edge portions 48c in the first positioning part 58a face toward each other across an interval in the direction (groove width direction) of the arrow C.

As shown in FIG. 4B, the first side 110a of the first positioning edge portions 46c in the second positioning part 58b is arranged at a position separated in the direction of the arrow B1 from a lateral side arranged on an end part in the direction of the arrow B2 of the separators 28, and is oriented along the direction of extension (the direction of the arrow C) of the lateral side. Similarly, the first side 110b of the second positioning edge portions 48c in the second positioning part 58b is arranged at a position separated in the direction of the arrow B1 from a lateral side arranged on an end part in the direction of the arrow B2 of the separators 28, and is oriented along the direction of extension (the direction of the arrow C) of the lateral side.

The pair of second sides 112a of the first positioning edge portions 46c in the second positioning part 58b face toward each other across an interval in the direction (groove width direction) of the arrow C. Similarly, the pair of second sides 112b of the second positioning edge portions 48c in the second positioning part 58b face toward each other across an interval in the direction (groove width direction) of the arrow C.

As shown in FIG. 4C, the first side 110a of the first positioning edge portions 46c in the third positioning part 58c is arranged at a position separated in the direction of the arrow C1 from a longitudinal side arranged on an end part in the direction of the arrow C2 of the separators 28, and is oriented along the direction of extension (the direction of the arrow B) of the longitudinal side. Similarly, the first side 110b of the second positioning edge portions 48c in the third positioning part 58c is arranged at a position separated in the direction of the arrow C1 from a longitudinal side arranged on an end part in the direction of the arrow C2 of the separators 28, and is oriented along the direction of extension (the direction of the arrow B) of the longitudinal side.

The pair of second sides 112a of the first positioning edge portions 46c in the third positioning part 58c face toward each other across an interval in the direction (groove width direction) of the arrow B. Similarly, the pair of second sides 112b of the second positioning edge portions 48c in the third positioning part 58c face toward each other across an interval in the direction (groove width direction) of the arrow B.

Hereinafter, in relation to the positioning parts 58, the lengths of the first sides 110a and 110b are also referred to as widths, and the lengths of the second sides 112a and 112b are also referred to as depths. The shape of the positioning parts 58 as viewed in the stacking direction is not limited to being a rectangular shape as shown in FIG. 3, etc. The shape of the positioning parts 58 as viewed in the stacking direction may be, for example, an arcuate shape, or a polygonal shape other than a rectangular shape. In the case that the shape of the positioning parts 58 as viewed in the stacking direction is a polygonal shape, the corners thereof may be rounded. Further, the arrangement and the number of the positioning parts 58 provided in the stacked units E are not limited to those shown in FIG. 3, and are capable of being set in various ways, for example, in accordance with at least one of the shapes of the separators 28 and the resin frame equipped MEAs 26.

Moreover, according to the present embodiment, as shown in FIG. 2, in the power generating cells 14, the outer edge portions of the resin frame members 32 are overlapped with the outer edge portions 28a of the separators 28. Groove portions 32a are provided on the outer edge portions of the resin frame members 32 at portions thereof facing toward the positioning parts 58 of the separators 28. As viewed in the stacking direction, the size of the groove portions 32a is larger than the size of the positioning parts 58. Stated otherwise, the depth of the groove portions 32a is larger than the depth of the positioning parts 58. The groove width of the groove portions 32a is larger than the groove width of the positioning parts 58. Therefore, as will be discussed later, at a time when inserted portions 86 of the guide bars 66 are inserted through the positioning parts 58, a situation is avoided in which the resin frame members 32 and the inserted portions 86 come into contact with each other.

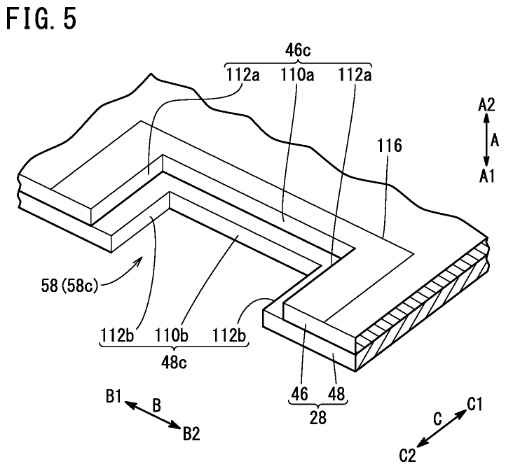

As shown in FIGS. 4A to 5, according to the present embodiment, a width of the positioning parts 58 of the first bipolar plate 46 is larger than a width of the positioning parts 58 of the second bipolar plate 48. A depth of the positioning parts 58 of the first bipolar plate 46 is larger than a depth of the positioning parts 58 of the second bipolar plate 48. Positions of the first positioning edge portions 46c and the second positioning edge portions 48c in the separator surface direction are different from each other. More specifically, the entirety of the second positioning edge portions 48c projects toward the outer side in the separator surface direction more so than the entirety of the first positioning edge portions 46c.

More specifically, the first side 110b of the second positioning edge portions 48c projects toward the outer side (on an inner side of the grooves of the positioning parts 58) in the separator surface direction more so than the first side 110a of the first positioning edge portions 46c. Further, each of the pair of second sides 112b of the second positioning edge portions 48c projects toward the outer side in the separator surface direction more so than each of the pair of second sides 112a of the first positioning edge portions 46c.

However, without being particularly limited to the configuration described above, it suffices if the positions in the separator surface direction of at least a portion of the first positioning edge portions 46c, and the positions in the separator surface direction of at least a portion of the second positioning edge portions 48c are arranged in a manner so as to differ from each other. In this case, in the first positioning edge portions 46c and the second positioning edge portions 48c, the position in the separator surface direction of at least one of the pair of second sides 112a, and the position in the separator surface direction of at least one of the pair of second sides 112b preferably differ from each other. More specifically, it is preferable for at least one of the following conditions A and B to be satisfied. Under condition A, the position in the separator surface direction of the second side 112a, which is arranged at an end part of the positioning parts 58 in the direction of the arrow B1, and the position in the separator surface direction of the second side 112b, which is arranged at an end part of the positioning parts 58 in the direction of the arrow B1, differ from each other. Under condition B, the position in the separator surface direction of the second side 112a, which is arranged at an end part of the positioning parts 58 in the direction of the arrow B2, and the position in the separator surface direction of the second side 112b, which is arranged at an end part of the positioning parts 58 in the direction of the arrow B2, differ from each other. In this case, the position of the first side 110a of the first positioning edge portions 46c in the separator surface direction and the position of the first side 110b of the second positioning edge portions 48c in the separator surface direction may be the same as each other, or may be different from each other.

In this case, although not shown in the drawings, for example, the width of the positioning parts 58 of the first bipolar plate 46 may be smaller than the width of the positioning parts 58 of the second bipolar plate 48. Although not shown in the drawings, the depth of the positioning parts 58 of the first bipolar plate 46, and the depth of the positioning parts 58 of the second bipolar plate 48 may be the same as each other.

Further, the width of the positioning parts 58 of the first bipolar plate 46 and the width of the positioning parts 58 of the second bipolar plate 48 may be the same as each other, and the depth of the positioning parts 58 of the first bipolar plate 46 and the depth of the positioning parts 58 of the second bipolar plate 48 may be the same as each other. In such cases, the positioning parts 58 of the first bipolar plate 46 and the positioning parts 58 of the second bipolar plate 48 are arranged so as to be shifted from each other in the groove width direction with respect to the separators 28 as viewed in the stacking direction. In accordance with this feature, only one of the pair of second sides 112a of the first positioning edge portions 46c projects toward the outer side in the separator surface direction more so than one of the second sides 112b of the second positioning edge portions 48c. Stated otherwise, the other one of the pair of second sides 112b of the second positioning edge portions 48c projects toward the outer side in the separator surface direction more so than the other one of the pair of second sides 112a of the first positioning edge portions 46c.

In the first positioning edge portions 46c and the second positioning edge portions 48c, only the positions in the separator surface direction of the first side 110a and the first side 110b may differ from each other, and the positions in the separator surface direction of the second sides 112a and the second sides 112b may be the same as each other.

Around the periphery of the positioning parts 58 of the separators 28, welded portions 116 where the first bipolar plate 46 and the second bipolar plate 48 are welded are provided along the positioning parts 58. More specifically, the welded portions 116 are provided in line-like shapes extending along the first side 110a and the second sides 112a, more on an inner side of the separators 28 than each of the first side 110a and the second sides 112a of the positioning parts 58.

Hereinafter, with reference to FIGS. 1 to 3, operations of the fuel cell stack 16 which is equipped with the power generating cell stacked body 12 will be briefly described. In the case that generation of electrical power is carried out by the fuel cell stack 16, the fuel gas is supplied to the fuel gas supply passages 44a. The oxygen containing gas is supplied to the oxygen containing gas supply passages 40a. The coolant is supplied to the coolant supply passages 42a.

As shown in FIG. 3, the oxygen containing gas is introduced from the oxygen containing gas supply passages 40a into the oxygen containing gas flow field 50. The oxygen containing gas introduced into the oxygen containing gas flow field 50 is supplied to the cathode 38 of the membrane electrode assembly 30 while moving along the oxygen containing gas flow field 50 in the direction of the arrow B. On the other hand, as shown in FIG. 2, the fuel gas is introduced from the fuel gas supply passages 44a into the fuel gas flow field 54. The fuel gas introduced into the fuel gas flow field 54 is supplied to the anode 36 of the membrane electrode assembly 30 while moving along the fuel gas flow field 54 in the direction of the arrow B.

Accordingly, in each of the membrane electrode assemblies 30, the oxygen containing gas that is supplied to the cathode 38 and the fuel gas that is supplied to the anode 36 are consumed in electrochemical reactions that take place in the cathode catalyst layer and the anode catalyst layer. Consequently, generation of electrical power is carried out.

The oxygen containing gas (oxygen containing exhaust gas) that is not consumed in the electrochemical reactions flows from the oxygen containing gas flow field 50 into the oxygen containing gas discharge passages 40b. The oxygen containing exhaust gas that has flowed into the oxygen containing gas discharge passages 40b flows through the oxygen containing gas discharge passages 40b in the direction of the arrow A, and is discharged from the fuel cell stack 16. Similarly, the fuel gas (fuel exhaust gas) that is not consumed in the electrochemical reactions flows from the fuel gas flow field 54 into the fuel gas discharge passages 44b. The fuel exhaust gas that has flowed into the fuel gas discharge passages 44b flows through the fuel gas discharge passages 44b in the direction of the arrow A, and is discharged from the fuel cell stack 16.

The coolant is introduced into the coolant flow field 56 from the coolant supply passages 42a. The coolant introduced into the coolant flow field 56, while moving along the coolant flow field 56 in the direction of the arrow B, undergoes heat exchange with the membrane electrode assembly 30. The coolant, after heat exchange has been carried out, flows into the coolant discharge passages 42b. The coolant that has flowed into the coolant discharge passages 42b flows through the coolant discharge passages 42b in the direction of the arrow A, and is discharged from the fuel cell stack 16.

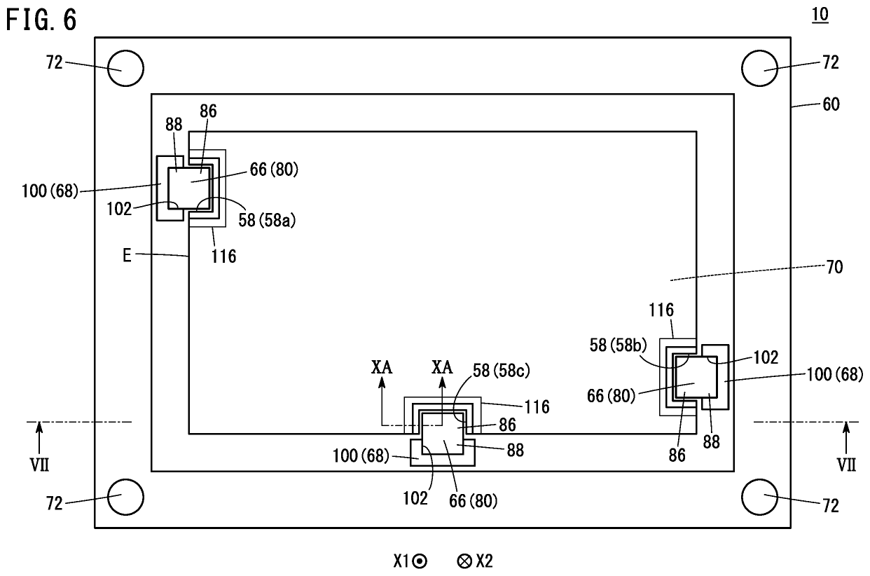

Hereinafter, a description will be given with reference to FIGS. 6 to 9 concerning an example of a manufacturing apparatus 10 for manufacturing the power generating cell stacked body 12, by stacking a plurality of the stacked units E while the positioning parts 58 are superimposed. The manufacturing apparatus 10, for example, can be applied to a case in which the power generating cell stacked body 12 shown in FIG. 1 is obtained by stacking the plurality of stacked units E in the stacking direction indicated by the arrow X. According to the present embodiment, the plurality of stacked units E are stacked in an upward direction (in the direction of the arrow X1). More specifically, the stacking direction of the stacked units E with respect to the manufacturing apparatus 10 is oriented along the vertical direction.

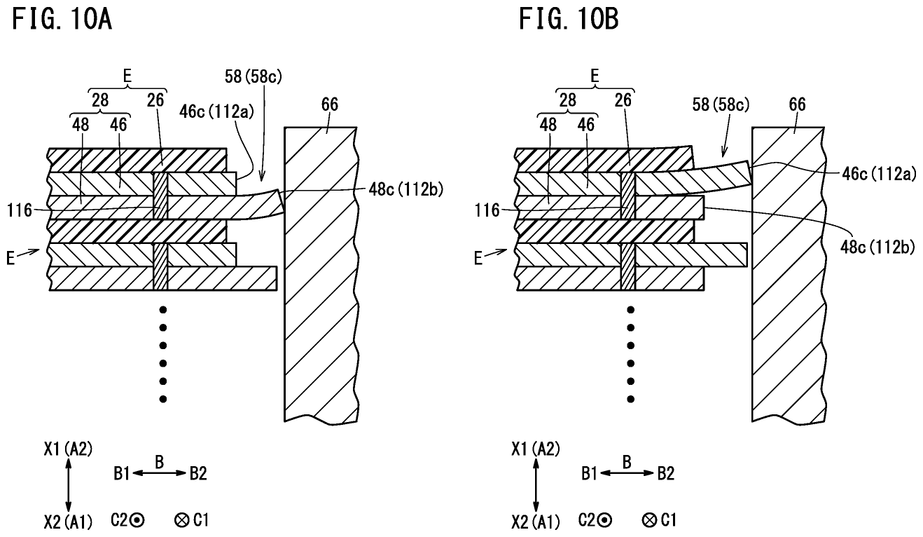

Further, as shown in FIGS. 6 to 9, according to the present embodiment, the direction of the arrow X2 of the manufacturing apparatus 10 corresponds to the direction of the arrow A1 of the separators 28 shown in FIGS. 1 to 5. Therefore, as shown in FIG. 10A, the stacked units E are stacked in a state in which the second bipolar plate 48 of the separators 28 is arranged below the first bipolar plate 46. Stated otherwise, at a time when the stacked units E are stacked from below to above, the second positioning edge portions 48c that project toward the outer side from the first positioning edge portions 46c in the separator surface direction are arranged below the first positioning edge portions 46c.

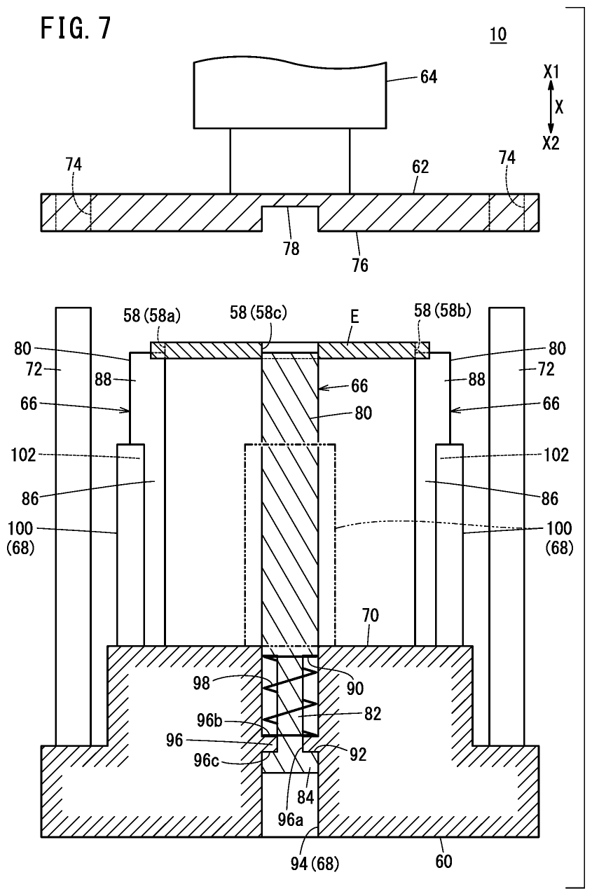

As shown in FIGS. 7 to 9, the manufacturing apparatus 10 comprises a mounting pedestal 60, a pressurizing unit 62, a drive mechanism 64, guide bars 66, and a support mechanism 68. Moreover, in the manufacturing apparatus 10 shown in FIG. 6, the pressurizing unit 62 and the drive mechanism 64 are not shown. Further, in a plan view of the stacked units E shown in FIG. 6, the positioning parts 58 are shown for the sake of convenience, regardless of whether or not the upper surface of the stacked units E are the separators 28. This is in order to describe the positional relationship between the positioning parts 58 and the guide bars 66.

The mounting pedestal 60 includes a mounting surface 70 on which the stacked units E are stacked in the stacking direction (the direction of the arrow X). The pressurizing unit 62 is driven by the drive mechanism 64. In accordance with this feature, the pressurizing unit 62 is capable of being placed in closed proximity to the mounting pedestal 60 along the stacking direction, or separated away from the mounting pedestal 60 along the stacking direction.

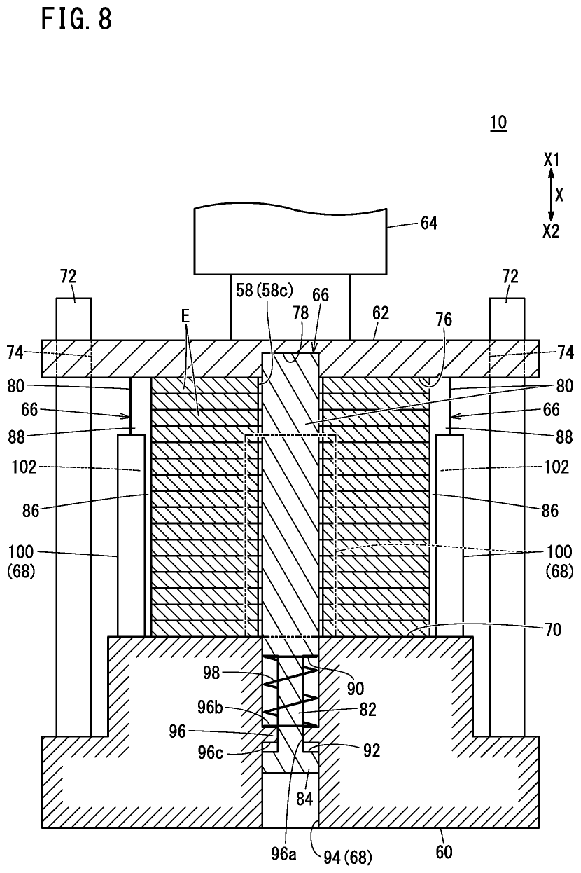

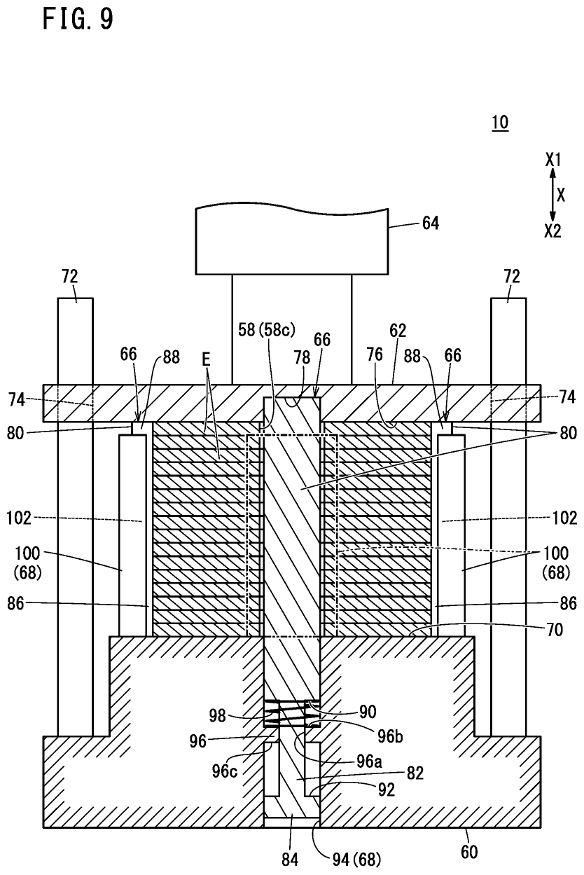

The guide posts 72 which extend in the stacking direction project outwardly from the mounting surface 70 of the mounting pedestal 60. Further, the pressurizing unit 62 is provided with engaging portions 74. As shown in FIGS. 8 and 9, when the pressurizing unit 62 comes into proximity to the mounting pedestal 60 at a predetermined distance, the engaging portions 74 and the guide posts 72 engage with each other. According to the present embodiment, the engaging portions 74 are through holes provided in the pressurizing unit 62. By the guide posts 72 being slidably inserted onto the engaging portions 74, the engaging portions 74 and the guide posts 72 engage with each other. In a state in which the engaging portions 74 are engaged with the guide posts 72, the pressurizing unit 62 comes into proximity to or separates away from the mounting pedestal 60, whereby the direction of movement of the pressurizing unit 62 is guided along the stacking direction.

Further, the pressurizing unit 62 is provided with a pressurizing surface 76 and contact portions 78. As shown in FIGS. 8 and 9, when the pressurizing unit 62 approaches toward the mounting pedestal 60, the pressurizing surface 76 is placed in contact with the stacked units E that are stacked on the mounting surface 70. When the pressurizing unit 62 approaches toward the mounting pedestal 60, the contact portions 78 are placed in contact with the upper surfaces of the guide bars 66.

The guide bars 66 project out in the stacking direction from the mounting surface 70 of the mounting pedestal 60. Further, the guide bars 66 are capable of being moved relative to the mounting surface 70 in the stacking direction. Therefore, in a state in which the contact portions 78 of the pressurizing unit 62 is in contact with the upper surfaces of the guide bars 66, by the pressurizing unit 62 being brought further into close proximity to the mounting pedestal 60, the guide bars 66 can be made to move integrally with the pressurizing unit 62 at the same speed.

According to the present embodiment, the guide bars 66 have a square rod-like shape extending along the stacking direction. Hereinafter, end parts of the guide bars 66 in close proximity to the mounting pedestal 60 in the direction of extension thereof are also referred to as proximal end parts (end parts in the direction of the arrow X2). End parts of the guide bars 66 on an opposite side from the mounting pedestal 60 in the direction of extension thereof are also referred to as distal end parts (end parts in the direction of the arrow X1). The guide bars 66 are provided, for example, corresponding to the number and the arrangement of the positioning parts 58 of the stacked units E in a state of being stacked on the mounting surface 70. Therefore, according to the present embodiment, as shown in FIG. 6, three guide bars 66 corresponding to the first positioning part 58a, the second positioning part 58b, and the third positioning part 58c of the stacked units E are provided on the mounting pedestal 60. These three guide bars 66 can be configured in the same manner as each other, except for the manner in which they are arranged with respect to the mounting surface 70.

More specifically, as shown in FIGS. 7 to 9, each of the guide bars 66 includes a main body portion 80, a narrow portion 82, and a stopper portion 84. The main body portion 80, the narrow portion 82, and the stopper portion 84 are arranged in this order from the distal end part toward the proximal end part in the direction of extension of the guide bars 66. Although illustration thereof is omitted, the narrow portion 82 and the stopper portion 84 are integrally provided in a separable manner. In the direction of extension of the main body portion 80, the majority of the distal end part of the main body portion 80 projects out from the mounting surface 70 in the stacking direction. At a time when a predetermined number of the stacked units E that make up the power generating cell stacked body 12 are stacked on the mounting surface 70, the length of the main body portion 80 that projects out from the mounting surface 70 is longer than the length in the stacking direction of the plurality of stacked units E.

Further, the main body portions 80 includes the inserted portions 86 and exposed portions 88. When the stacked units E are stacked on the mounting surface 70, the inserted portions 86 are inserted through the positioning parts 58 of the stacked units E. When the inserted portions 86 are inserted through the positioning parts 58, the exposed portions 88 are arranged on an outer side of the positioning parts 58 in the stacking direction. Stated otherwise, the shape of the main body portions 80 in the stacking direction corresponds to the shape of the positioning parts 58 in the stacking direction. According to the present embodiment, the shape of the guide bars 66 in the stacking direction is rectangular. The length of a side along the widthwise direction of the positioning parts 58 is slightly shorter than the width of the positioning parts 58. Further, the length of a side along the depth direction of the positioning parts 58 is longer than the depth of the positioning parts 58.

In a state in which the inserted portions 86 are inserted through the positioning parts 58 in the manner described above, the stacked units E are stacked on the mounting surface 70 while the positioning parts 58 are aligned with the guide bars 66. Consequently, the stacked units E can be guided to predetermined stacking positions on the mounting surface 70. In the plurality of stacked units E which are stacked on the mounting surface 70 in this manner, the respective positioning parts 58 thereof are overlapped with each other in the stacking direction via the guide bars 66. Consequently, it becomes possible for the plurality of stacked units E to be stacked in a mutually positioned state.

Although not shown in the drawings, the external dimension of a cross section of the narrow portion 82 perpendicular to the direction of extension thereof is smaller than the external dimension of a cross section of the main body portion 80 perpendicular to the direction of extension thereof. The external dimension of a cross section of the narrow portion 82 perpendicular to the direction of extension thereof is smaller than the external dimension of a cross section of the stopper portion 84 perpendicular to the direction of extension thereof. Therefore, a first stepped portion 90 is formed between the main body portion 80 and the narrow portion 82. Further, a second stepped portion 92 is formed between the narrow portion 82 and the stopper portion 84. According to the present embodiment, although the external dimensions of the main body portion 80 and the stopper portion 84 are the same as each other, they may be different from each other.

The proximal end part of the main body portion 80, the narrow portion 82, and the stopper portion 84 can be inserted into a support hole 94. The support hole 94 is formed along the stacking direction in the mounting pedestal 60. The proximal end part of the main body portion 80, the narrow portion 82, and the stopper portion 84 are capable of moving along the stacking direction inside the support hole 94. Although not shown in the drawings, the dimension of a cross section perpendicular to the direction of extension of the support hole 94 is the same as the external dimension of each of the main body portion 80 and the stopper portion 84, or slightly larger than the external dimension of each of the main body portion 80 and the stopper portion 84. Therefore, the main body portion 80 and the stopper portion 84 are capable of sliding along the stacking direction inside the support hole 94. In accordance with this feature, the direction in which the guide bars 66 extend is maintained in a state of being oriented along the stacking direction.

A throttle (reduced diameter) section 96 is provided in the support hole 94. The throttle section 96 is arranged between the first stepped portion 90 and the second stepped portion 92 of the guide bar 66 that is inserted into the support hole 94. The throttle section 96 projects out from the inner wall surface of the support hole 94 toward the center of the support hole 94 as viewed in the direction of extension of the support hole 94. Further, a through hole 96a through which the narrow portion 82 is inserted is formed at the central portion of the throttle section 96. Although not shown in the drawings, the dimension of a cross section of the through hole 96a in a direction perpendicular to the direction of extension of the support hole 94 is smaller than the external dimension of each of the main body portion 80 and the stopper portion 84. Further, the dimension of the cross section of the through hole 96a in a direction perpendicular to the direction of extension of the support hole 94 is slightly larger than the aforementioned external dimension of the narrow portion 82.

An end surface 96b of the distal end part of the throttle section 96 faces toward the first stepped portion 90 at a certain interval. An elastic member 98 is arranged between the end surface 96b of the distal end part of the throttle section 96 and the first stepped portion 90. In the present embodiment, the elastic member 98 is a coil spring, and the direction of expansion and contraction thereof is along the stacking direction. Further, the narrow portion 82 is inserted through the inner side of the elastic member 98. Due to the elastic members 98, the guide bars 66 are elastically biased in a direction so as to project out from the mounting surface 70.

An end surface 96c of the proximal end portion of the throttle section 96 faces toward the second stepped portion 92 so as to be capable of contacting the second stepped portion 92. As described previously, by the end surfaces 96c of the proximal end portions of the throttle sections 96 and the second stepped portions 92 coming into contact with each other, the guide bars 66, which are elastically biased by the elastic members 98, are restricted from moving further in a direction to project out from the mounting surface 70 (see FIG. 7). Further, as shown in FIGS. 8 and 9, the elastic members 98 are elastically deformed in a direction in which the elastic members 98 are compressed between the end surfaces 96b of the distal end portions of the throttle sections 96 and the first stepped portions 90. Consequently, the guide bars 66 are capable of being moved in a direction of entering into the mounting surface 70. When the guide bars 66 are moved in the direction of entering into the mounting surface 70, the second stepped portions 92 separate away from the end surfaces 96c of the proximal end portions of the throttle sections 96.

In the vicinity of the guide bars 66 of the mounting pedestal 60, support bars 100 that project along the guide bars 66 in the stacking direction are provided. The support bars 100 are fixed to the mounting pedestal 60. Recesses 102 (see FIG. 6) are formed in the support bars 100. The exposed portions 88 of the guide bars 66 are accommodated in the recesses 102 in a manner so as to be slidable in the stacking direction. A projecting length of the support bars 100 from the mounting surface 70 is shorter than the length in the stacking direction of the plurality of stacked units E that are compressed on the mounting surface 70 as will be described later (see FIG. 9). The support bars 100 and the support holes 94 of the mounting pedestal 60 constitute the support mechanism 68. In the support mechanism 68, the support bars 100 and the support holes 94 of the mounting pedestal 60 support the guide bars 66 so as to be capable of moving in the stacking direction. In accordance with this feature, the direction of extension of the guide bars 66 can be maintained in a state of being oriented along the stacking direction.

Hereinafter, a description will be given concerning an example of a manufacturing method for obtaining the power generating cell stacked body 12 shown in FIG. 1, by stacking the plurality of stacked units E using the manufacturing apparatus 10 shown in FIGS. 6 to 9. In the method of manufacturing the power generating cell stacked body 12, initially, a stacked unit forming step is performed. In the stacked unit forming step, the separators 28 and the resin frame equipped MEAs 26 (membrane electrode assemblies 30) are stacked in a state in which positioning thereof is carried out, thereby forming the stacked units E. The outer edge portions of the resin frame members 32 are joined to the outer edge portions of the separators 28 by way of welding or adhesion.

Next, a stacking step is performed. In the stacking step, as shown in FIG. 7, the pressurizing unit 62 is moved by the drive mechanism 64 to a position separated away from the mounting pedestal 60. As a result, the contact portions 78 of the pressurizing unit 62 are also separated away from the guide bars 66. Therefore, due to the elastic force of the elastic members 98, the guide bars 66 are disposed at positions where the second stepped portions 92 are placed in contact with the end surfaces 96c of the throttle sections 96 in the support holes 94 of the mounting pedestal 60. Stated otherwise, the projecting length of the main body portions 80 from the mounting surface 70 is maximized.

In this state, a predetermined number of the stacked units E that make up the power generating cell stacked body 12 are stacked on the mounting surface 70. More specifically, the inserted portions 86 of the plurality of guide bars 66 are inserted in the stacking direction, respectively, into the plurality of the positioning parts 58 of each of the stacked units E. At this time, as described above, in the positioning parts 58, the second positioning edge portions 48c are arranged on a more lower side than the first positioning edge portions 46c (see FIG. 10A). The second positioning edge portions 48c project toward the outer side in the separator surface direction more so than the first positioning edge portions 46c.

Then, the stacked units E are moved downward while the positioning parts 58 are aligned with the inserted portions 86. The movement thereof may be carried out by dropping the stacked units E onto the mounting surface 70 in a state in which the inserted portions 86 are inserted through the positioning parts 58.

By the positioning parts 58 being aligned with the inserted portions 86 in the manner described above, the stacked units E are guided to their stacking positions. In this manner, by carrying out stacking while each of the plurality of stacked units E is guided to its stacking position, the positioning parts 58 of each of the stacked units E are positioned in a state of being superimposed in the stacking direction via the guide bars 66. More specifically, a predetermined number of the stacked units E can be stacked on the mounting surface 70 in a state in which positional deviation from each other is suppressed.

Next, a compression step is carried out. In the compression step, by the drive mechanism 64, the pressurizing unit 62 is brought into close proximity to the mounting pedestal 60 on which the plurality of stacked units E have been stacked in the stacking step. Consequently, as shown in FIG. 8, the pressurizing surface 76 of the pressurizing unit 62 is placed in contact with the stacked units E. Further, the contact portions 78 of the pressurizing unit 62 are placed in contact with the distal end portions of the guide bars 66. From this state, as shown in FIG. 9, by further bringing the pressurizing unit 62 into closer proximity to the mounting pedestal 60, a plurality of the stacked units E are compressed between the mounting surface 70 of the mounting pedestal 60 and the pressurizing surface 76 of the pressurizing unit 62.

At this time, the guide bars 66 are also pressed against the pressurizing unit 62 via the contact portions 78. Therefore, the guide bars 66 are moved in a direction of entering into the interior of the support holes 94 of the mounting pedestal 60 in opposition to the elastic force of the elastic members 98. More specifically, in the compression step, the plurality of stacked units E are compressed while the guide bars 66, in a state of being aligned with the inserted portions 86 in the positioning parts 58, undergo movement in the same direction as the direction of movement of the pressurizing unit 62.

Moreover, in the compression step, the timing at which the pressurizing surface 76 and the stacked units E are placed in contact may be the same as the timing at which the contact portions 78 and the distal end parts of the guide bars 66 are placed in contact, or the timing thereof may take place earlier. For example, by adjusting the relative positioning in the stacking direction between the pressurizing surface 76 and the contact portions 78, the timing at which the pressurizing surface 76 abuts against the stacked units E and the timing at which the contact portions 78 abut against the guide bars 66 can be adjusted. For example, by adjusting the projecting length of the main body portions 80 from the mounting surface 70, it is possible to adjust the timing at which the pressurizing surface 76 abuts against the stacked units E, and the timing at which the contact portions 78 abut against the guide bars 66. Therefore, in the compression step, it is possible to adjust the relationship between the timing at which the stacked units E are compressed and movement thereof is initiated, and the timing at which movement of the guide bars 66 is initiated.

Next, for example, by a non-illustrated fixing mechanism, the plurality of stacked units E are maintained in a state of being compressed by the compression step. Consequently, it is possible to obtain the power generating cell stacked body 12 to which a compressive load is applied in a state in which the stacked units E are positioned with each other.

Moreover, the magnitude of the compressive load applied to the plurality of stacked units E in the compression step can be set in various ways as necessary. Further, the compression step may be performed a plurality of times with a releasing step taking place therebetween. In the releasing step, the pressurizing unit 62 is moved by the drive mechanism 64 in a direction to separate away from the mounting pedestal 60, to thereby cause the compressive load to be reduced or reduced to zero. In accordance with this feature, for example, it is possible to apply an aging treatment or the like to the plurality of stacked units E in order to cause an initial amount of creeping therein to advance.

Taking into consideration the above-described features, in the separators 28 according to the present embodiment, the positioning parts 58 are provided in which the stacked units E are positioned due to being superimposed on each other in the stacking direction. Therefore, for example, by using the manufacturing apparatus 10 to stack the plurality of stacked units E on the mounting pedestal 60 while aligning the positioning parts 58 along the guide bars 66, etc., the positioning parts 58 themselves can be superimposed in the stacking direction. Consequently, the plurality of stacked units E can be easily stacked in a state of being positioned with each other.

Further, each of the separators 28 is made up from a bonded body of the first bipolar plate 46 and the second bipolar plate 48. In the separators 28, positions in the separator surface direction of the first positioning edge portions 46c, and positions in the separator surface direction of the second positioning edge portions 48c differ from each other. The first positioning edge portions 46c are edge portions of the positioning parts 58 of the first bipolar plate 46. The second positioning edge portions 48c are edge portions of the positioning parts 58 of the second bipolar plate 48. Therefore, when the plurality of stacked units E are stacked in a mutually positioned state in the manner described above, it is possible to avoid a situation in which both the first positioning edge portions 46c and the second positioning edge portions 48c are oriented along the guide bars 66. More specifically, it becomes possible to reduce the contact area between the positioning parts 58 and the guide bars 66. As a result, any frictional forces generated between the positioning parts 58 and the guide bars 66 can be reduced, and deformation of the separators 28 can be suppressed.

Therefore, in accordance with the method of manufacturing the separators 28 and the power generating cell stacked body 12 equipped with the separators 28 according to the present embodiment, the stacked units E can be easily and highly accurately positioned with each other, and deformation of the separators 28 can be suppressed.

Furthermore, in the above-described embodiment, when the plurality of stacked units E are subjected to compression between the mounting pedestal 60 and the pressurizing unit 62, the guide bars 66 are aligned with the positioning parts 58, and the relative positioning of the stacked units E themselves is maintained. Consequently, the plurality of stacked units E can be compressed in the stacking direction while effectively suppressing a deviation in the relative positioning of the stacked units E. In this manner, when the compressive force is applied to the plurality of stacked units E in a state in which the guide bars 66 are aligned with the positioning parts 58, due to friction and the like taking place between the positioning parts 58 and the guide bars 66, it becomes easy for bending stresses to occur around the periphery of the positioning parts 58.

In this case as well, in the separators 28 according to the present embodiment, as described above, the contact area between the positioning parts 58 and the guide bars 66 can be reduced. Therefore, frictional forces generated between the positioning parts 58 and the guide bars 66 can be reduced. As a result, it is possible to obtain the power generating cell stacked body 12 by applying a compressive load to the plurality of stacked units E, while suppressing deviation between the stacked units E and deformation of the separators 28.

In the separators 28 for the fuel cell according to the above-described embodiment, preferably, one of the first positioning edge portions 46c and the second positioning edge portions 48c projects more toward an outer side in the separator surface direction than the other, and one of the first positioning edge portions 46c and the second positioning edge portions 48c is arranged on a more lower side than the other at a time when the stacked units E are stacked from below to above.

In the method of manufacturing the power generating cell stacked body 12 according to the present embodiment described above, in the stacked unit forming step, in the separators 28 that form the stacked bodies E, one of the first positioning edge portions 46c and the second positioning edge portions 48c projects more toward an outer side in the separator surface direction than the other, and in the stacking step, the stacked units E are stacked from below to above in a state in which one of the first positioning edge portions 46c and the second positioning edge portions 48c is arranged on a more lower side than the other.

According to the present embodiment, as shown in FIG. 10A, the second positioning edge portions 48c project toward the outer side in the separator surface direction more so than the first positioning edge portions 46c. Further, the second positioning edge portions 48c are arranged on a more downward side than the first positioning edge portions 46c at the time that the stacked units E are stacked from below to above. In this case, in the second positioning edge portions 48c, which come into contact with the guide bars 66 at the time when the stacked units E are stacked, due to frictional forces of the guide bars 66, stresses may occur in a direction of being deformed toward the upper side.

Moreover, for example, as shown in FIG. 10B, the first positioning edge portions 46c, which are arranged more on an upper side than the second positioning edge portions 48c at the time when the stacked units E are stacked from below to above, may project toward the outer side in the separator surface direction more so than the second positioning edge portions 48c. In this case, in the first positioning edge portions 46c, which come into contact with the guide bars 66 at the time when the stacked units E are stacked, due to frictional forces of the guide bars 66, stresses may occur in a direction of being deformed toward the upper side.

According to the embodiment shown in FIG. 10A, even if the aforementioned stresses occur, the first positioning edge portions 46c are arranged on an upper side of the second positioning edge portions 48c. Therefore, in the embodiment shown in FIG. 10A, deformation of the second positioning edge portions 48c can be effectively suppressed, for example, more so than in the embodiment shown in FIG. 10B. Further, in the embodiment shown in FIG. 10A, it is possible to suppress the application of forces in a direction that causes the first bipolar plates 46 and the second bipolar plates 48 to be separated at the welded portions 116. Therefore, in the embodiment shown in FIG. 10A, it is possible to more effectively suppress deformation of the separators 28.

However, in the embodiment shown in FIG. 10B as well, frictional forces generated between the second positioning edge portions 48c and the guide bars 66 can be reduced. Therefore, in the embodiment shown in FIG. 10B as well, deformation of the separators 28 can more effectively be suppressed than a case in which frictional forces are generated between both of the first positioning edge portions 46c and the second positioning edge portions 48c and the guide bars 66.

Incidentally, in an embodiment in which the second positioning edge portions 48c project toward the outer side in the separator surface direction more so than the first positioning edge portions 46c, the positioning parts 58 may be provided by subjecting the outer edge portions of the second bipolar plates 48 to a cutting process. In the cutting process, the outer edge portions of the second bipolar plates 48 are cut by a non-illustrated cutting blade. In this case, it is preferable to cause the cutting blade to be moved with respect to the second bipolar plates 48 from a lower surface toward an upper surface of the second bipolar plates 48 at the time when stacking is carried out in the stacking step. In accordance therewith, burrs are formed on the second positioning edge portions 48c from the lower surface toward the upper surface of the second bipolar plates 48 at the time that stacking is carried out in the stacking step. By the burrs being formed with such an orientation, frictional forces generated between the second positioning edge portions 48c and the guide bars 66 can be effectively reduced. Hence, it becomes possible for deformation of the separators 28 to be more effectively suppressed. Moreover, in an embodiment in which the first positioning edge portions 46c project toward the outer side in the separator surface direction more so than the second positioning edge portions 48c, the cutting blade is preferably made to move in the above-described direction with respect to the first bipolar plates 46.

In the separators 28 for the fuel cell according to the above-described embodiment, the positioning parts 58 are, at a portion of the outer edge portions 28a of the separators 28, grooves that are recessed from the outer side toward the inner side of the separators 28. In this case, the positioning parts 58 can be easily provided on the separators 28. Even if the positioning parts 58 are provided, it is possible to avoid a situation in which the outer shape of the separators 28 becomes large. The plurality of stacked units E can be easily positioned with each other by means of a simple configuration in which the rod-shaped guide bars 66 are inserted into the groove-shaped positioning parts 58.

The positioning parts 58 may be convex portions that project toward an outer side in the separator surface direction from the outer edge portions 28a of the separators 28. In this case, it suffices if the positions in the separator surface direction of the edge portions of the convex portions of the positioning parts 58 in the first bipolar plates 46, and the positions in the separator surface direction of the edge portions of the convex portions of the positioning parts 58 in the second bipolar plates 48 differ from each other. It suffices if grooves (not shown) that extend along the stacking direction are formed in the guide bars 66. The stacked units E are stacked on the mounting surface 70 in a state in which the positioning parts 58 are inserted through such grooves. Consequently, it is possible for the stacked units E to be guided to the stacking positions. Further, although not illustrated, the positioning parts 58 may be through holes that penetrate through the separators 28 in the thickness direction.

In the separators 28 for the fuel cell according to the above-described embodiment, each of the first positioning edge portions 46c and the second positioning edge portions 48c includes a pair of sides (the second sides 112a of the first positioning edge portions 46c, the second sides 112b of the second positioning edge portions 48c) that face toward each other with intervals therebetween in a groove width direction of the positioning parts 58, and a position of at least one of the pair of sides in the separator surface direction differs mutually between the first positioning edge portions 46c and the second positioning edge portions 48c. In each of the second sides 112a and 112b of the positioning parts 58, end parts thereof in the direction of extension are connected to the outer edge portions 28a of the separators 28. Therefore, when frictional forces are generated between the second sides 112a and 112b and the guide bars 66, the second sides 112a and 112b tend to be more easily deformed than the first sides 110a and 110b. Thus, the positions of the second sides 112a of the first positioning edge portions 46c and the second sides 112b of the second positioning edge portions 48c differ from each other in the separator surface direction. Consequently, since the frictional forces generated between the second sides 112a and 112b and the guide bars 66 can be reduced, with a simple configuration, deformation of the separators 28 can be effectively suppressed.

In the fuel cell stack 16 according to the above-described embodiment, the separators 28 are of a rectangular shape having the pair of longitudinal sides that face toward each other, and the pair of lateral sides that face toward each other, wherein the positioning parts 58 include the first positioning parts 58a provided in one of the pair of lateral sides, the second positioning parts 58b provided in the other of the pair of lateral sides, and the third positioning parts 58c provided in either one of the pair of longitudinal sides of the separators 28.

Further, in the fuel cell stack 16 according to the above-described embodiment, the first positioning parts 58a and the second positioning parts 58b are arranged at diagonal positions of the separators 28, and the third positioning parts 58c are positioned in the center of the longitudinal side of the separators 28.

By providing the positioning parts 58 in the manner described above, positional deviation between the stacked units E can be effectively suppressed. Further, by providing the positioning parts 58 in the manner described above, it is possible to effectively suppress deformation of the separators 28.

The present invention is not limited to the embodiments described above, and various configurations could be adopted therein without deviating from the essence and gist of the present invention.

What is claimed is:

1. A separator for a fuel cell configured to be stacked on an membrane electrode assembly in which electrodes are arranged on both sides of an electrolyte membrane to thereby form a stacked unit, wherein:
a plurality of the stacked units are stacked in a stacking direction to thereby form a power generating cell stacked body;
the separator is a connected body of a first bipolar plate and a second bipolar plate that are stacked on each other;
the separator is provided with a positioning structure;
the positioning structure comprises a positioning part provided for the first bipolar plate and a positioning part provided for the second bipolar plate;
the stacked units are positioned by superimposing the positioning structures of a plurality of the separators in the stacking direction;
the positioning part of the first bipolar plate and the positioning part of the second bipolar plate are disposed at positions overlapping each other in the stacking direction;
the first bipolar plate comprises a first positioning edge portion that is an edge portion of the positioning part of the first bipolar plate;
the second bipolar plate comprises a second positioning edge portion that is an edge portion of the positioning part of the second bipolar plate; and
a position of the first positioning edge portion in a separator surface direction that is perpendicular with respect to a thickness direction of the separator, and a position of the second positioning edge portion in the separator surface direction differ from each other.

2. The separator for a fuel cell according to claim 1, wherein, in the positioning structure, a portion of an outer edge portion of the separator comprises a groove, a shape of which is cut out from an outer side to an inner side of the separator.

3. The separator for a fuel cell according to claim 2, wherein each of the first positioning edge portion and the second positioning edge portion includes a pair of sides configured to face toward each other with an interval therebetween in a groove width direction of the positioning structure, and a position of at least one of the pair of sides in the separator surface direction differs mutually between the first positioning edge portion and the second positioning edge portion.

4. A method of manufacturing a power generating cell stacked body in which a plurality of stacked units, in which there are superimposed a membrane electrode assembly having electrodes arranged on both surfaces of an electrolyte membrane and a separator, are stacked in a stacking direction to thereby obtain the power generating cell stacked body;
wherein the separators comprise positioning structures in which the stacked units are positioned with respect to each other by being superimposed in the stacking direction;
the method of manufacturing the power generating cell stacked body comprising:
a stacked unit forming step of forming the stacked units from the separators and the membrane electrode assemblies; and
a stacking step of stacking the plurality of stacked units on a mounting pedestal, by aligning the positioning structures of the stacked units with a guide bar configured to project out from the mounting pedestal in the stacking direction, while superimposing the positioning structures of the plurality of stacked units in the stacking direction;
wherein each of the separators is made up from a connected body of a first bipolar plate and a second bipolar plate that are stacked on each other, the positioning structure comprises a positioning part provided for the first bipolar plate and a positioning part provided for the second bipolar plate, the positioning part of the first bipolar plate and the positioning part of the second bipolar plate are disposed at positions overlapping each other in the stacking direction, and a first positioning edge portion that is an edge portion of the positioning part of the first bipolar plate, and a second positioning edge portion that is an edge portion of the positioning part of the second bipolar plate are at different positions in a separator surface direction that is perpendicular with respect to a thickness direction of the separator.

5. The method of manufacturing a power generating cell stacked body according to claim 4, wherein:
in the separators, one of the first positioning edge portion and the second positioning edge portion projects more toward an outer side in the separator surface direction than the other; and
in the stacking step, the stacked units are stacked from below to above in a state in which one of the first positioning edge portion and the second positioning edge portion is arranged on a more lower side than the other.
